(19) United States
(12) Patent Application Publication
(10) Pub. No.: US 2024/0070581 A1
(43) Pub. Date: Feb. 29, 2024

(54) INFORMATION PROCESSING METHOD, INFORMATION PROCESSING APPARATUS, INFORMATION PROCESSING SYSTEM, AND NON-TRANSITORY COMPUTER READABLE MEDIUM

(71) Applicant: TOYOTA JIDOSHA KABUSHIKI KAISHA, Toyota-shi (JP)

(72) Inventors: Chikage KUBO, Chofu-shi (JP); Kenichi YAMADA, Nisshin-shi (JP); Yuki TATSUMOTO, Seto-shi (JP); Hiromitsu FUJII, Kariya-shi (JP); Mitsuhiro NAITO, Okazaki-shi (JP)

(73) Assignee: TOYOTA JIDOSHA KABUSHIKI KAISHA, Toyota-shi (JP)

(21) Appl. No.: 18/451,239

(22) Filed: Aug. 17, 2023

(30) Foreign Application Priority Data
Aug. 25, 2022 (JP) 2022-134470

(51) Int. Cl. G06Q 10/0631; G06Q 30/0202

(52) U.S. Cl. CPC G06Q 10/06314; G06Q 30/0202

(57) ABSTRACT

An information processing method, for an information processing apparatus including a controller, includes a first step, by the controller, of acquiring positional information indicating a change over time in positions of a plurality of users, a second step, by the controller, of predicting a number of the users who will gather at a specific time at a boarding/alighting point to board/alight from a vehicle based on the change over time in the positions of the plurality of users indicated by the positional information, and a third step, by the controller, of determining a vehicle dispatch schedule for the vehicle to the boarding/alighting point based on the number of users predicted to gather at the specific time at the boarding/alighting point.

### CROSS-REFERENCE TO RELATED APPLICATION

This application claims priority to Japanese Patent Application No. 2022-134470 filed on Aug. 25, 2022, the entire contents of which are incorporated herein by reference.

### TECHNICAL FIELD

The present disclosure relates to an information processing method, an information processing apparatus, an information processing system, and a non-transitory computer readable medium.

### BACKGROUND

Patent Literature (PTL) 1 describes determining whether a user intends to board a mobile object, which is a means of transportation, based on the positional relationship between the boarding point for boarding the mobile object and the user's current location, and on behavior information indicating the user's behavior.

### CITATION LIST

### Patent Literature

PTL 1: JP 2019-057265 A

### SUMMARY

However, a conventional configuration has room for improvement in the accuracy of vehicle demand prediction.

It would be helpful to improve the accuracy of vehicle demand prediction.

An information processing method according to an embodiment of the present disclosure is an information processing method for an information processing apparatus including a controller, the information processing method including:
a first step, by the controller, of acquiring positional information indicating a change over time in positions of a plurality of users;
a second step, by the controller, of predicting a number of the users who will gather at a specific time at a boarding/alighting point to board/alight from a vehicle based on the change over time in the positions of the plurality of users indicated by the positional information; and
a third step, by the controller, of determining a vehicle dispatch schedule for the vehicle to the boarding/alighting point based on the number of users predicted to gather at the specific time at the boarding/alighting point.

An information processing apparatus according to an embodiment of the present disclosure includes a controller configured to:
acquire positional information indicating a change over time in positions of a plurality of users;
predict a number of the users who will gather at a specific time at a boarding/alighting point to board/alight from a vehicle based on the change over time in the positions of the plurality of users indicated by the positional information; and
determine a vehicle dispatch schedule for the vehicle to the boarding/alighting point based on the number of users predicted to gather at the specific time at the boarding/alighting point.

An information processing system according to an embodiment of the present disclosure includes the aforementioned information processing apparatus and the plurality of terminal apparatuses.

A non-transitory computer readable medium according to an embodiment of the present disclosure is a non-transitory computer readable medium storing a program configured to cause a computer to execute:
a first process of acquiring positional information indicating a change over time in positions of a plurality of users;
a second process of predicting a number of the users who will gather at a specific time at a boarding/alighting point to board/alight from a vehicle based on the change over time in the positions of the plurality of users indicated by the positional information; and
a third process of determining a vehicle dispatch schedule for the vehicle to the boarding/alighting point based on the number of users predicted to gather at the specific time at the boarding/alighting point.

According to an embodiment of the present disclosure, the accuracy of vehicle demand prediction can be improved.

### BRIEF DESCRIPTION OF THE DRAWINGS

In the accompanying drawings:

FIG. 1 illustrates a configuration example of an information processing system according to an embodiment of the present disclosure;

FIG. 2 is a block diagram illustrating a hardware configuration example of a control apparatus in FIG. 1;

FIG. 3 is a block diagram illustrating a hardware configuration example of a terminal apparatus in FIG. 1;

FIG. 4 is a block diagram illustrating a hardware configuration example of a vehicle in FIG. 1;

FIG. 5 is a flowchart illustrating an example of operations of the control apparatus;

FIG. 6 is a flowchart illustrating an example of a process to predict the number of passengers in FIG. 5; and

FIG. 7 is a flowchart illustrating an example of a process to determine a vehicle dispatch schedule in FIG. 5.

### DETAILED DESCRIPTION

An embodiment of the present disclosure will be described below, with reference to the drawings. In the drawings, portions having the same configuration or function are denoted by the same reference numerals. In the description of the present embodiment, duplicate descriptions of the same portions are in some cases omitted or simplified, as appropriate.

(Outline of Embodiment)

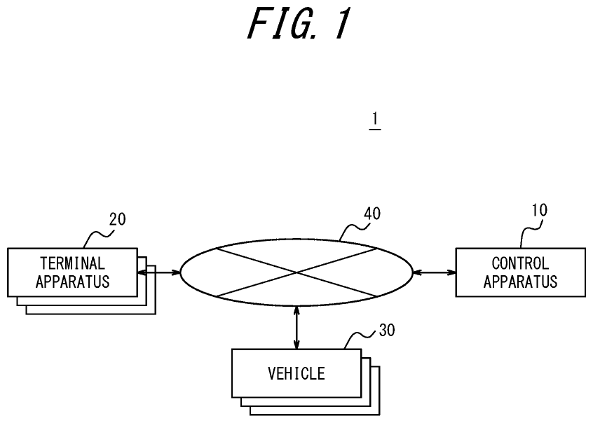

FIG. 1 illustrates a configuration example of an information processing system 1 according to an embodiment of the present disclosure. The information processing system 1 includes a control apparatus 10, terminal apparatuses 20, and vehicles 30. The control apparatus 10, the terminal apparatuses 20, and the vehicles 30 are communicably connected to a network including, for example, the Internet, a mobile communication network, and the like.

The control apparatus 10 as the information processing apparatus according to the present embodiment is an information processing apparatus that determines the vehicle dispatch schedule of the vehicles 30 based on positional information and the like indicating the change over time in the positions of a plurality of users. The control apparatus 10 may, for example, be a computer, such as a server apparatus, installed in a data center or other facility. The control apparatus 10 can communicate with the terminal apparatuses 20 and the vehicles 30 via the network 40.

Each terminal apparatus 20 is an information processing apparatus held and operated by a user. The terminal apparatus 20 may transmit information such as information indicating its position to the control apparatus 10. The terminal apparatus 20 is a smartphone used by the user in the present embodiment but may also be a mobile device, such as a mobile phone or tablet, as well as a general purpose device such as a personal computer (PC). The number of terminal apparatuses 20 included in the information processing system 1 may be freely determined. In the present embodiment, an example in which a plurality of users each hold one terminal apparatus 20 is described, but this configuration is not limiting. For example, each user may hold a plurality of terminal apparatuses 20, or the same terminal apparatus 20 may be used by two or more users.

Each vehicle 30 is an automobile, such as a bus, but is not limited to this and may be any vehicle. The automobile is, for example, a gasoline vehicle, a hybrid electric vehicle (HEV), a plug-in hybrid electric vehicle (PHEV), a fuel cell electric vehicle (FCEV), a battery electric vehicle (BEV), or the like, but is not limited to these. Each vehicle 30 is an autonomous vehicle (AV) in the present embodiment, but the vehicle 30 may be driven by a driver, or the driving may be automated at any level. The automation level is, for example, any one of Level 1 to Level 5 according to the level classification defined by the Society of Automotive Engineers (SAE). Each vehicle 30 may be a Mobility as a Service (MaaS) dedicated vehicle. The number of vehicles 30 included in the information processing system 1 may be freely determined.

The vehicle 30 operates as an on-demand vehicle with a vehicle dispatch schedule (operation route, operation schedule, and the like) determined in response to a user request (demand). The operation route and operation time of the vehicle 30 are not predetermined, and the control apparatus 10 dynamically determines the vehicle dispatch schedule according to the user's position and the user's request (demand). The vehicle 30 transmits and receives various information, including information representing the vehicle dispatch schedule, through communication with the control apparatus 10, and travels according to the vehicle dispatch schedule in a predetermined target area. The vehicle 30 is a passenger bus that an unspecified number of users board and alight but may also be a vehicle that a specific number of users board and alight. In the present embodiment, an example is described in which the boarding/alighting points for the users to board and alight the vehicle 30 are predetermined, but the boarding/alighting points may also be dynamically determined according to the users' requests. The number of vehicles 30 included in the information processing system 1 may be freely determined.

In the above configuration, the control apparatus 10 is heading to a predetermined boarding/alighting point (for example, a bus stop in front of a station), predicts the number of users who can arrive at that boarding/alighting point by a specific time, and determines a dispatch schedule for the vehicles 30 based on that number. Specifically, the control apparatus 10 acquires positional information indicating a change over time in the positions of a plurality of users. The control apparatus 10 predicts the number of users who will gather at a specific time at a certain boarding/alighting point based on the change over time in the positions of the plurality of users indicated by the positional information. The control apparatus 10 determines the vehicle dispatch schedule for the vehicles 30 to the boarding/alighting point based on the number of users predicted to gather at the specific time at the boarding/alighting point. Based on the determined vehicle dispatch schedule, the control apparatus 10 controls the dispatch of each vehicle 30 by transmitting information such as the operation route and operation time to each vehicle 30. In this way, the control apparatus 10 predicts the number of users who will gather at a specific time at a certain boarding/alighting point based on the change over time in the positions of the users and determines the vehicle dispatch schedule for the vehicles 30 based on the results, thereby enabling highly accurate prediction of the demand for the vehicles 30.

(Control Apparatus Configuration)

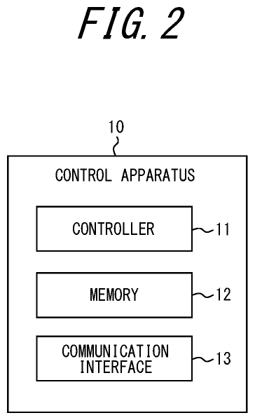

FIG. 2 is a block diagram illustrating a hardware configuration example of the control apparatus 10 in FIG. 1. As illustrated in FIG. 2, the control apparatus 10 includes a controller 11, a memory 12, and a communication interface 13.

The controller 11 includes at least one processor, at least one programmable circuit, at least one dedicated circuit, or a combination of these. The controller 11 controls operations of the entire control apparatus 10.

The memory 12 includes one or more memories. The memories included in the memory 12 may each function as, for example, a main memory, an auxiliary memory, or a cache memory. The memory 12 stores any information used for operations of the control apparatus 10. For example, the memory 12 may store a system program, an application program, a database, map information, positional information for each user, the vehicle dispatch schedule for each vehicle 30, and the like. The information stored in the memory 12 may be updated with, for example, information acquired from the network 40 via the communication interface 13.

The communication interface 13 includes at least one interface for communication for connecting to the network 40. The interface for communication is compliant with, for example, mobile communication standards, wired local area network (LAN) standards, or wireless LAN standards, but is not limited to these, and may be compliant with any communication standards. In the present embodiment, the control apparatus communicates with the terminal apparatuses 20 and the vehicles 30 via the communication interface 13 and the network 40.

In the present embodiment, the positional information for the boarding/alighting points, the operation status of the vehicle 30, and the like in the target service area may be stored in the memory 12 of the control apparatus 10. The operation management of the vehicles 30 in the target service area is performed on the control apparatus 10. Alternatively, the storage operations and the operation management of the vehicles 30 may be handled on a network storage or information processing apparatus separate from the control apparatus 10 for each on-demand vehicle service provider.

(Configuration of Terminal Apparatus)

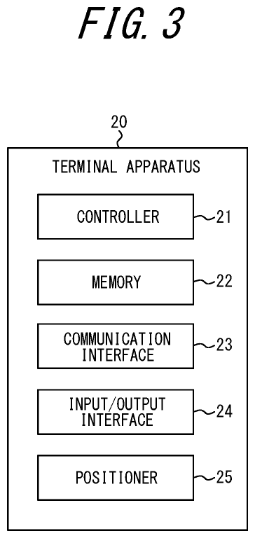

FIG. 3 is a block diagram illustrating a hardware configuration example of the terminal apparatus 20 in FIG. 1. As illustrated in FIG. 3, the terminal apparatus 20 includes a controller 21, a memory 22, a communication interface 23, an input/output interface 24, and a positioner 25.

The controller 21 includes at least one processor, at least one programmable circuit, at least one dedicated circuit, or a combination of these. The controller 21 controls operations of the entire terminal apparatus 20.

The memory 22 includes one or more memories. The memories included in the memory 22 may each function as, for example, a main memory, an auxiliary memory, or a cache memory. The memory 22 stores any information used for operations of the terminal apparatus 20. For example, the memory 22 may store a system program, an application program, map information, or the like. The information stored in the memory 22 may be updated with, for example, information acquired from the network 40 via the communication interface 23.

The communication interface 23 includes at least one interface for communication for connecting to the network 40. The interface for communication is compliant with, for example, a mobile communication standard or a wireless LAN standard but is not limited to these and may be compliant with any communication standard. In the present embodiment, the terminal apparatus 20 communicates with the control apparatus 10 via the communication interface 23 and the network 40.

The input/output interface 24 is a Human Machine Interface (HMI) that accepts input operations from the user and outputs the processing results of the terminal apparatus 20 to the user. The input/output interface 24 is, for example, configured as a touch screen integrated provided with a display, but this example is not limiting. For example, the input/output interface 24 may accept input operations from the user using physical keys, capacitive keys, a pointing device, a microphone, or the like. The input/output interface 24 may also output information to the user through a speaker or vibrator.

The positioner 25 includes at least one apparatus for acquiring positional information for the terminal apparatus 20. Specifically, the positioner 25 includes a receiver corresponding to the Global Positioning System (GPS), for example, but is not limited to this and may include a receiver corresponding to any satellite positioning system.

The terminal apparatus 20 may periodically transmit information indicating the position of the terminal apparatus 20, as acquired by the positioner 25, along with identification information on the user to the control apparatus 10 as positional information indicating the change over time in the position of the user holding the corresponding terminal apparatus 20.

(Configuration of Vehicle)

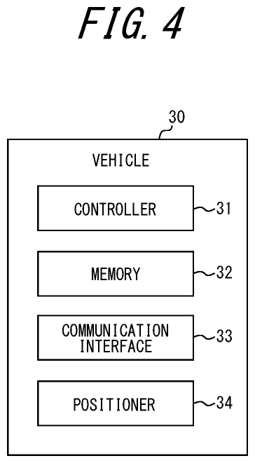

FIG. 4 is a block diagram illustrating a hardware configuration example of the vehicle 30 in FIG. 1. As illustrated in FIG. 4, the vehicle 30 includes a controller 31, a memory 32, a communication interface 33, and a positioner 34.

The controller 31 includes at least one processor, at least one programmable circuit, at least one dedicated circuit, or a combination of these. The controller 31 controls operations of the entire vehicle 30.

The memory 32 includes one or more memories. The memories included in the memory 32 may each function as, for example, a main memory, an auxiliary memory, or a cache memory. The memory 32 stores any data used for the operations of the vehicle 30. For example, the memory 32 may store a system program, an application program, map information, or the like. The information stored in the memory 32 may be updated with, for example, information acquired from the network 40 via the communication interface 33.

The communication interface 33 includes at least one interface for communication for connecting to the network 40. The interface for communication is compliant with mobile communication standards, for example, but is not limited to these and may be compliant with any communication standard. In the present embodiment, the vehicle 30 communicates with the control apparatus 10 via the communication interface 33 and the network 40.

The positioner 34 includes one or more apparatuses configured to acquire positional information for the vehicle 30. Specifically, the positioner 34 includes a receiver corresponding to the Global Positioning System (GPS), for example, but is not limited to this and may include a receiver corresponding to any satellite positioning system.

Each vehicle 30 runs according to a vehicle dispatch schedule received from the control apparatus 10. Each vehicle 30 also transmits information on the position of the vehicle 30 measured by the positioner 34 to the control apparatus 10.

(Operation Flow)

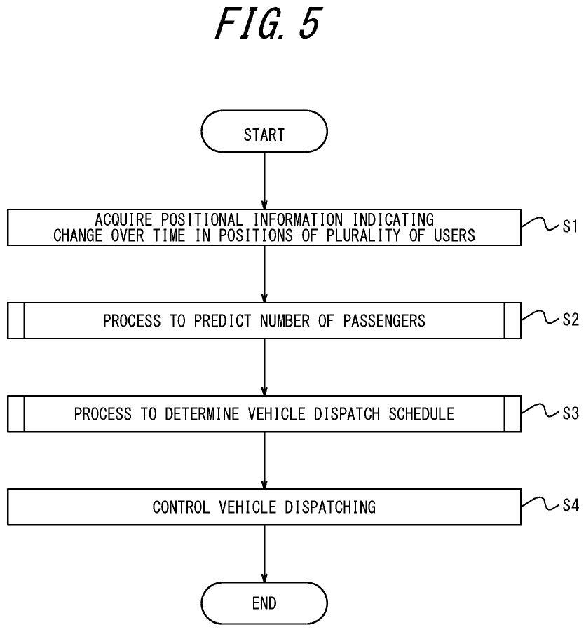

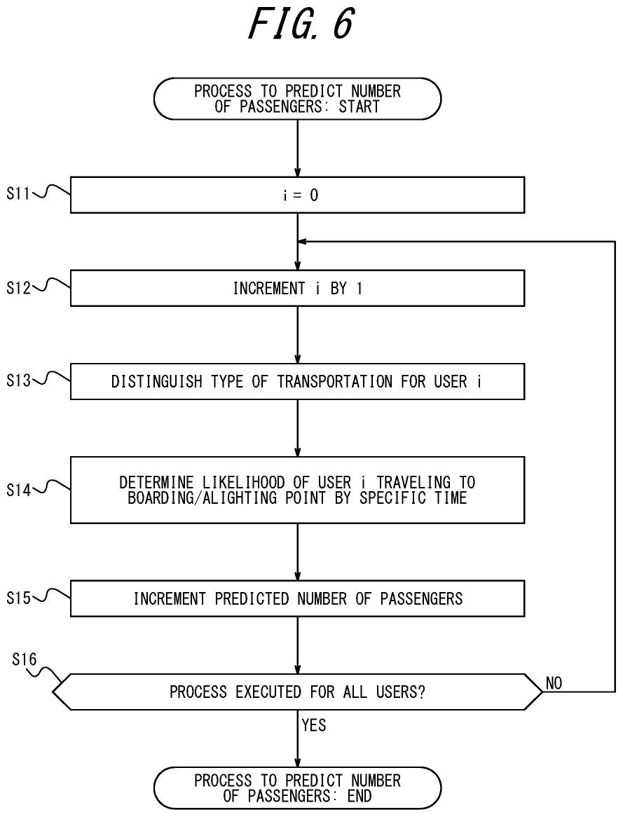

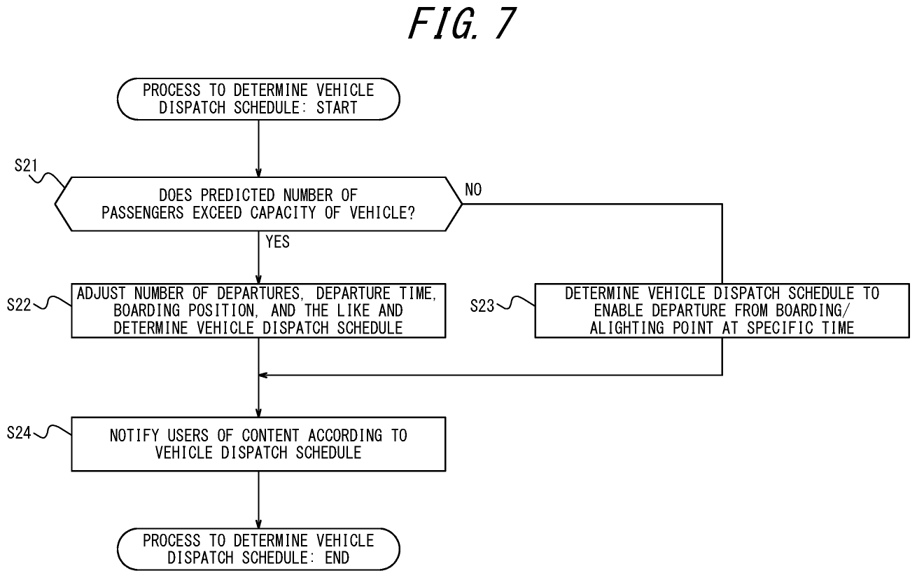

Operations of the information processing system 1 are described with reference to FIGS. 5 to 7. FIG. 5 is a flowchart illustrating an example of operations of the control apparatus 10. FIG. 6 is a flowchart illustrating an example of a process to predict the number of passengers in FIG. 5. FIG. 7 is a flowchart illustrating an example of a process to determine a vehicle dispatch schedule in FIG. 5. The operations of the control apparatus 10 described with reference to FIGS. 5 to 7 can correspond to at least a portion of an information processing method according to the present embodiment. The steps in FIGS. 5 to 7 are performed under the control of the controller 11 in the control apparatus 10. In the example described below, the demand for a vehicle 30 is predicted and the vehicle dispatch schedule is determined for a case of dispatching a vehicle 30 scheduled to depart at a specific time, such as 16:00, from a bus stop X in front of station A, for example, as a specific boarding/alighting point.

In step S1, the controller 11 acquires positional information indicating the change over time in the positions of a plurality of users. Specifically, the controller 11 may, for example, acquire information indicating the position of the terminal apparatus 20, received periodically from the terminal apparatus 20, as positional information indicating the change over time in the position of the user holding the corresponding terminal apparatus 20. Here, the controller 11 may identify the user holding the terminal apparatus 20 by the user identification information received from the terminal apparatus 20. Alternatively, in a case in which a sensor installed at the entry gate of a building, on the street, or at another such location recognizes the user, and in response, transmits the user's identification information to the control apparatus 10, the controller 11 may generate and thereby acquire positional information based on such identification information. For example, the controller 11 may generate and thereby acquire the positional information for the user by associating the identification information received from the sensor with the position of the sensor and the time.

In step S2, the controller 11 executes a process to predict the number of passengers. The process to predict the number of passengers is a process to predict the number of users (number of passengers) who will gather at a specific time at a boarding/alighting point to board/alight from a vehicle 30, based on the change over time in the positions of the plurality of users indicated by the positional information acquired in step S1. The details of the process to predict the number of passengers are described below with reference to FIG. 6.

In step S3, the controller 11 executes a process to determine a vehicle dispatch schedule. In step S2, the process to determine the vehicle dispatch schedule determines the vehicle dispatch schedule of the vehicle 30 to the boarding/alighting point (for example, bus stop X in front of station A) based on the number of users predicted to gather at a specific time (for example, 16:00) at the boarding/alighting point. Details of the process to determine the vehicle dispatch schedule are described below with reference to FIG. 7.

In step S4, the controller 11 controls the dispatching of each vehicle according to the vehicle dispatch schedule determined in step S3. Specifically, for example, the controller 11 may transmit a command, to each vehicle 30, for the vehicle 30 to operate according to the operation route, operation time, and the like indicated by the vehicle dispatch schedule. After finishing the process in step S4, the controller 11 terminates the processing of the flowchart in FIG. 5.

Next, referring to FIG. 6, the process executed in step S2 of FIG. 5 to predict the number of passengers is explained. As described above, the process to predict the number of passengers is a process to predict the number of users who will gather at a specific time at a certain boarding/alighting point, based on the change over time in the positions of the plurality of users indicated by the positional information acquired in step S1 of FIG. 5. In the example in FIG. 6, the controller 11 determines, for each user, the likelihood that the user will travel to a certain boarding/alighting point (for example, bus stop X in front of station A) by a specific time (for example, 16:00), and calculates the predicted number of passengers based on the results of the determination. As a precondition for the following processes, the controller 11 sets the “predicted number of passengers” to 0 before starting the processes from step S11 onward.

In step S11, the controller 11 sets i=0. The parameter i is for identifying the user. The i^{th} user is hereinafter referred to as “user i”.

In step S12, the controller 11 increments i by 1. In a case in which step S12 is executed immediately after step S11, the value of i becomes 0+1=1.

In step S13, the controller 11 distinguishes the type of transportation of the user i. Such types of transportation include, for example, railway, automobile, bicycle, and walking, but the examples listed here are not limiting.

Specifically, for example, the controller 11 may distinguish the type of transportation of the user i based on the positional information acquired in step S1 of FIG. 5. For example, the controller 11 may distinguish the type of transportation as “railway” in a case in which the user i is traveling along a route, where a railway line exists, at a speed comparable to that of a railway vehicle traveling along that line. For example, the controller 11 may distinguish the type of transportation as “automobile” in a case in which the user i is traveling along a route, where a road exists, at a speed comparable to that of an automobile traveling along that road. For example, the controller 11 may distinguish the type of transportation of the user i as “walking” in a case in which the type of transportation of the user i does not correspond to either “rail” or “automobile”.

The controller 11 may also distinguish the type of transportation of the user i by receiving information, from the terminal apparatus 20 held by the user i, indicating the type of transportation of the user i holding that terminal apparatus 20. For example, in a case in which the user i passes through an automatic ticket gate using the terminal apparatus 20 at a railway station, the terminal apparatus 20 may notify the control apparatus 10 that the type of transportation of the user i is “railway”. Alternatively, for example, the terminal apparatus 20 may distinguish the type of transportation based on the change over time in the position of the terminal apparatus 20, the pattern of vibration measured by a vibration sensor, and the like and notify the control apparatus 10 of the distinguished type of transportation. In a case in which the user inputs the type of transportation to the terminal apparatus 20, for example, the terminal apparatus 20 may also notify the control apparatus 10 of the inputted type of transportation.

In step S14, the controller 11 determines whether the user i will travel to a certain boarding/alighting point by a specific time based on, for example, the change over time in the position of the user i, the type of transportation, a behavioral pattern, and the like.

Specifically, the controller 11 may, for example, analyze the change over time in the position of the user i and determine the likelihood that the user i will travel to a boarding/alighting point (for example, bus stop X in front of station A) by a specific time (for example, 16:00). For example, the controller 11 may predict the future travel trajectory based on the change over time in the position of the user i up to the present and determine the likelihood that the user i will travel to the boarding/alighting point by the specific time based on the result of the prediction.

For example, in a case in which the type of transportation distinguished in step S13 is railway, the controller 11 may identify the railway vehicle ridden by the user and determine the likelihood that the user i will travel to the boarding/alighting point by the specific time based on the operation status of the railway vehicle.

Here, the controller 11 may, for example, identify the railway vehicle ridden by the user i based on the change over time in the position of the user i as indicated by the positional information. Specifically, the controller 11 may compare the change over time in the position of the user with the timetable information for the railway and determine that the railway vehicle whose timetable information best matches the change over time in the position of the user i is the railway vehicle ridden by the user i. Alternatively, the controller 11 may receive, for example, identifying information for identifying the railway vehicle ridden by the user i from the terminal apparatus 20 held by the user i and identify the railway vehicle ridden by the user i based on that identifying information. Here, the terminal apparatus 20 may, for example, identify the railway vehicle based on the change over time in the position of the user i, operations by the user i, or the like and notify the control apparatus of the identified railway vehicle.

Once a railway vehicle is identified, the controller 11 may refer to the operation status of that railway vehicle and determine that, in a case in which the railway vehicle is scheduled to arrive at a station near the boarding/alighting point (for example, station A) by a specific time, travel to the boarding/alighting point (for example, bus stop X) by that specific time is likely. The controller 11 may access a database or the like for managing train schedules to acquire such train schedule information. In this way, the controller 11 can identify the railway vehicle ridden by the user i and use information on the operation status of that railway vehicle to determine with even higher accuracy the likelihood that the user i will travel to the boarding/alighting point by a specific time.

For example, in a case in which the distinguished type of transportation is an automobile, the controller 11 may determine whether the user i can arrive at the boarding/alighting point by a specific time based on the travel trajectory (change over time in position) of the vehicle, time of travel, status of road congestion, and the like. The controller 11 may, for example, refer to information from a road traffic information and communication system (VICS®: Vehicle Information and Communication System; VICS is a registered trademark in Japan, other countries, or both) to acquire the status of road congestion.

In commuting to and from work and school, for example, the user's behavioral patterns, such as the travel route and time of travel, are often constant. Therefore, the controller 11 may learn and acquire such a behavioral pattern of each user in advance and may determine the likelihood that the user i will travel to the boarding/alighting point by a specific time based on the learned data indicating the behavioral patterns of the user i. For example, in a case in which the change over time in the position of the user i up to a certain point in time conforms to one of the behavioral patterns indicated by the training data, the controller 11 may predict that the user i's subsequent behavior will be in accord with that behavioral pattern. In a case in which it is determined that the user i can arrive at the boarding/alighting point by a specific time based on such a prediction, the controller 11 may determine that the user i is likely to travel to the boarding/alighting point by the specific time. The controller 11 may, for example, learn in advance the behavioral patterns of users for each of various types, including type of transportation such as railway, automobile, or walking; time of day; and weekday or holiday, and may predict the behavior of the user i based on learned data for behavioral patterns compatible with such types. In this way, by determining the likelihood that the user i will travel to a boarding/alighting point by a specific time based on the learned data indicating the behavioral patterns of each user, the controller 11 can predict, with even higher accuracy, the number of users who will gather at a specific time at a boarding/alighting point.

The controller 11 may, for example, calculate an evaluation value indicating the likelihood of travel to a certain boarding/alighting point by a specific time based on the change over time in the position of the user i, the type of transportation, a behavioral pattern, and the like. For example, the controller 11 may calculate a value equal to or greater than 0 and equal to or less than 1 as such an evaluation value. Here, the controller 11 may further use other information in calculating the evaluation value of the likelihood of travel to a certain boarding/alighting point by a specific time. For example, in a case in which the boarding/alighting point is on the site of a company, such as a factory or sales office, the controller 11 may calculate the likelihood of travel based on the work attendance, need for overtime, amount of overtime, and the like for that day. Alternatively, the controller 11 may, for example, further use information on the status of road congestion, the operation status of the train schedule, and the like. In this way, by using various information such as the change over time in the position of the user i, the type of transportation, and behavioral patterns, the controller 11 can determine, with even higher accuracy, the likelihood of each user boarding.

In step S15, the controller 11 increments the predicted number of passengers based on the likelihood that the user i will travel to a certain boarding/alighting point by a specific time, as determined in step S14.

Specifically, in a case in which the controller 11 calculates a value equal to or greater than 0 and equal to or less than 1 as the evaluation value indicating the likelihood of travel, the controller 11 may increment the predicted number of passengers by the evaluation value. In this way, the controller 11 can predict the number of passengers more precisely by incrementing the predicted number of passengers by a value corresponding to the evaluation value.

In step S16, the controller 11 determines whether the processes in steps S13 through S15 have been executed for all users. In a case in which the processes have been executed (YES in step S16), the controller 11 terminates the process to predict the number of passengers and starts the process to determine the vehicle dispatch schedule (S3 in FIG. 5, FIG. 7). Otherwise (NO in step S16), the controller 11 returns to step S12.

Although in FIG. 6, the number of users who will gather at the boarding/alighting point at a specific time is predicted based on the likelihood that each user will travel so as to arrive at the boarding/alighting point by a specific time (for example, 16:00), the method for predicting the number of users who will gather is not limited to this method. For example, the controller 11 may determine the number of users who will gather based on the likelihood that the user i will arrive at the boarding/alighting point during a time period (for example, 15:30 to 16:00 or 16:00 to 16:30) corresponding to a specific time (for example, 16:00). Alternatively, in a case in which the terminal apparatus 20 provides notification that the user i wishes to board a vehicle 30 departing from the boarding/alighting point at a specific time, the controller 11 may assume that the user i is likely to board and may increment the predicted number of passengers by a value closer to 1 in step S16. By executing such a process, the controller 11 can predict with even higher accuracy the number of users who will gather at a specific time at a boarding/alighting point.

Next, referring to FIG. 7, the process executed in step S3 of FIG. 5 to determine the vehicle dispatch schedule is explained.

In step S21, the controller 11 determines whether the number of passengers predicted in the process to predict the number of passengers (S2 in FIG. 5, FIG. 6) exceeds the capacity of the vehicle 30. In a case of exceeding (YES in step S21), the controller 11 advances to step S22. Otherwise (NO in step S21), the controller 11 advances to step S23.

In step S22, the controller 11 determines the vehicle dispatch schedule by adjusting the number of departures of the vehicle 30, the departure time, the boarding position, and the like.

Specifically, the controller 11 may arrange to dispatch an additional vehicle 30 at a specific time (for example, 16:00) so that all users can board. Alternatively, the controller 11 may also dispatch vehicles 30 at times close to the specific time (for example, 16:05, 16:10) so that all users who are expected to gather by 16:10 can board. Alternatively, in addition to a predetermined boarding/alighting point (for example, bus stop X in front of station A), the controller 11 may also dispatch a vehicle to another boarding/alighting point near that boarding/alighting point (for example, bus stop Y by another ticket gate in front of station A, or bus stop Z in front of station B next to station A). In this way, by determining the vehicle dispatch schedule by adjusting the number of departures of the vehicle 30, the departure time, the boarding position, and the like, the controller 11 can appropriately dispatch vehicles according to the demand for boarding the vehicle 30.

In step S23, the controller 11 determines the vehicle dispatch schedule so that the vehicle 30 can depart from the boarding/alighting point (for example, bus stop X in front of station A) at a specific time (for example, 16:00).

In step S24, the controller 11 notifies the users of the content according to the vehicle dispatch schedule.

Specifically, the controller 11 may, for example, notify a user who is now to board the vehicle 30 at a different boarding position (for example, bus stop Z in front of station B) than the original boarding position (for example, bus stop X in front of station A) of the boarding position where the user is to board the vehicle 30. Alternatively, the controller 11 may, for example, notify all users of the boarding position and boarding time at which they can board the vehicle 30. In this way, by the users being notified of the content according to the determined vehicle dispatch schedule, the users can recognize the vehicle dispatch schedule and take appropriate action to board the vehicle 30.

While the present disclosure has been described with reference to the drawings and embodiments, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the control apparatus 10 in the above embodiment are distributed to multiple computers capable of communicating with each other can be implemented. For example, an embodiment in which some or all of the components of the control apparatus 10 are provided in the terminal apparatus or the vehicle 30 can also be implemented.

For example, an embodiment in which a general purpose computer functions as the control apparatus 10 according to the above embodiment can also be implemented. Specifically, a program in which processes for realizing the functions of the control apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] An information processing method for an information processing apparatus comprising a controller, the information processing method comprising:
a first step, by the controller, of acquiring positional information indicating a change over time in positions of a plurality of users;
a second step, by the controller, of predicting a number of the users who will gather at a specific time at a boarding/alighting point to board/alight from a vehicle based on the change over time in the positions of the plurality of users indicated by the positional information; and
a third step, by the controller, of determining a vehicle dispatch schedule for the vehicle to the boarding/alighting point based on the number of users predicted to gather at the specific time at the boarding/alighting point.
   [Appendix 2] The information processing method according to appendix 1, wherein in the first step, the controller acquires the positional information by receiving information, from each terminal apparatus in a plurality of terminal apparatuses held by the plurality of users, indicating a position of the terminal apparatus.
   [Appendix 3] The information processing method according to appendix 1 or 2, wherein in the second step, the controller
distinguishes a type of transportation for each user in the plurality of users, and
predicts the number of users who will gather at the specific time at the boarding/alighting point based further on the type of transportation distinguished for each user in the plurality of users.
   [Appendix 4] The information processing method according to appendix 3, wherein in the second step, the controller
identifies a railway vehicle ridden by a first user whose distinguished type of transportation is a railway,
determines a likelihood that the first user will travel to the boarding/alighting point by the specific time based on an operation status of the identified railway vehicle, and
predicts the number of the users who will gather at the specific time at the boarding/alighting point based further on the likelihood, determined for the first user, that the first user will travel to the boarding/alighting point by the specific time.
   [Appendix 5] The information processing method according to appendix 4, wherein in the second step, the controller identifies the railway vehicle ridden by the first user based on a change over time in a position of the first user as indicated by the positional information.
   [Appendix 6] The information processing method according to appendix 4, wherein in the second step, the controller
receives, from a terminal apparatus held by the first user, identification information for identifying the railway vehicle ridden by the first user, and
identifies the railway vehicle ridden by the first user based on the identification information.
   [Appendix 7] The information processing method according to any one of appendices 1 to 6, wherein in the second step, the controller
determines, for each user in the plurality of users, a likelihood that the user will travel to the boarding/alighting point by the specific time based on learning data indicating a behavioral pattern of each user, and
predicts the number of the users who will gather at the specific time at the boarding/alighting point based on the likelihood, determined for each user in the plurality of users, that the user will travel to the boarding/alighting point by the specific time.
   [Appendix 8] The information processing method according to any one of appendices 1 to 7, wherein in the third step, the controller determines the vehicle dispatch schedule to dispatch an additional vehicle in a case in which the number of the users predicted to gather at the specific time at the boarding/alighting point exceeds a capacity of the vehicle.
   [Appendix 9] The information processing method according to any one of appendices 1 to 7, wherein in the third step, the controller adjusts at least one of a number of departures of the vehicle and a departure time at the boarding/alighting point and determines the vehicle dispatch schedule in a case in which the number of the users predicted to gather at the specific time at the boarding/alighting point exceeds a capacity of the vehicle.
   [Appendix 10] The information processing method according to any one of appendices 1 to 7, wherein in the third step, the controller
adjusts a boarding position for boarding the vehicle and determines the vehicle dispatch schedule in a case in which the number of the users predicted to gather at the specific time at the boarding/alighting point exceeds a capacity of the vehicle, and
provides notification of a boarding position for boarding the vehicle to the user who, in the determined vehicle dispatch schedule, is to board the vehicle at a different boarding position than the boarding/alighting point.
   [Appendix 11] An information processing apparatus comprising a controller configured to:
acquire positional information indicating a change over time in positions of a plurality of users;
predict a number of the users who will gather at a specific time at a boarding/alighting point to board/alight from a vehicle based on the change over time in the positions of the plurality of users indicated by the positional information; and
determine a vehicle dispatch schedule for the vehicle to the boarding/alighting point based on the number of users predicted to gather at the specific time at the boarding/alighting point.
   [Appendix 12] The information processing apparatus according to appendix 11, wherein the controller is configured to
distinguish a type of transportation for each user in the plurality of users, and
predict the number of users who will gather at the specific time at the boarding/alighting point based further on the type of transportation distinguished for each user in the plurality of users.
   [Appendix 13] The information processing apparatus according to appendix 12, wherein the controller is configured to
identify a railway vehicle ridden by a first user whose distinguished type of transportation is a railway,
determine a likelihood that the first user will travel to the boarding/alighting point by the specific time based on an operation status of the identified railway vehicle, and
predict the number of the users who will gather at the specific time at the boarding/alighting point based further on the likelihood, determined for the first user, that the first user will travel to the boarding/alighting point by the specific time.
   [Appendix 14] The information processing apparatus according to appendix 13, wherein the controller is configured to identify the railway vehicle ridden by the first user based on a change over time in a position of the first user as indicated by the positional information.
   [Appendix 15] The information processing apparatus according to any one of appendices 11 to 14, wherein the controller is configured to
determine, for each user in the plurality of users, a likelihood that the user will travel to the boarding/alighting point by the specific time based on learning data indicating a behavioral pattern of each user, and
predict the number of the users who will gather at the specific time at the boarding/alighting point based on the likelihood, determined for each user in the plurality of users, that the user will travel to the boarding/alighting point by the specific time.
   [Appendix 16] The information processing apparatus according to any one of appendices 11 to 15, wherein the controller is configured to determine the vehicle dispatch schedule to dispatch an additional vehicle in a case in which the number of the users predicted to gather at the specific time at the boarding/alighting point exceeds a capacity of the vehicle.
   [Appendix 17] The information processing apparatus according to any one of appendices 11 to 15, wherein the controller is configured to adjust at least one of a number of departures of the vehicle and a departure time at the boarding/alighting point and determine the vehicle dispatch schedule in a case in which the number of the users predicted to gather at the specific time at the boarding/alighting point exceeds a capacity of the vehicle.
   [Appendix 18] The information processing apparatus according to any one of appendices 11 to 17, further comprising a communication interface configured to communicate with a plurality of terminal apparatuses used by the plurality of users, wherein the controller is configured to
adjust a boarding position for boarding the vehicle and determine the vehicle dispatch schedule in a case in which the number of the users predicted to gather at the specific time at the boarding/alighting point exceeds a capacity of the vehicle, and
provide notification of a boarding position for boarding the vehicle to the terminal apparatus held by the user who, in the determined vehicle dispatch schedule, is to board the vehicle at a different boarding position than the boarding/alighting point.
   [Appendix 19] An information processing system comprising:
the information processing apparatus according to appendix 18; and
the plurality of terminal apparatuses.
   [Appendix 20] A non-transitory computer readable medium storing a program configured to cause a computer to execute:
a first process of acquiring positional information indicating a change over time in positions of a plurality of users;
a second process of predicting a number of the users who will gather at a specific time at a boarding/alighting point to board/alight from a vehicle based on the change over time in the positions of the plurality of users indicated by the positional information; and
a third process of determining a vehicle dispatch schedule for the vehicle to the boarding/alighting point based on the number of users predicted to gather at the specific time at the boarding/alighting point.

1. An information processing method for an information processing apparatus comprising a controller, the information processing method comprising:
a first step, by the controller, of acquiring positional information indicating a change over time in positions of a plurality of users;
a second step, by the controller, of predicting a number of the users who will gather at a specific time at a boarding/alighting point to board/alight from a vehicle based on the change over time in the positions of the plurality of users indicated by the positional information; and
a third step, by the controller, of determining a vehicle dispatch schedule for the vehicle to the boarding/alighting point based on the number of users predicted to gather at the specific time at the boarding/alighting point.

2. The information processing method according to claim 1, wherein in the first step, the controller acquires the positional information by receiving information, from each terminal apparatus in a plurality of terminal apparatuses held by the plurality of users, indicating a position of the terminal apparatus.

3. The information processing method according to claim 1, wherein in the second step, the controller
distinguishes a type of transportation for each user in the plurality of users, and
predicts the number of users who will gather at the specific time at the boarding/alighting point based further on the type of transportation distinguished for each user in the plurality of users.

4. The information processing method according to claim 3,
wherein in the second step, the controller identifies a railway vehicle ridden by a first user whose distinguished type of transportation is a railway,
determines a likelihood that the first user will travel to the boarding/alighting point by the specific time based on an operation status of the identified railway vehicle, and
predicts the number of the users who will gather at the specific time at the boarding/alighting point based further on the likelihood, determined for the first user, that the first user will travel to the boarding/alighting point by the specific time.

5. The information processing method according to claim 4, wherein in the second step, the controller identifies the railway vehicle ridden by the first user based on a change over time in a position of the first user as indicated by the positional information.

6. The information processing method according to claim 4, wherein in the second step, the controller
receives, from a terminal apparatus held by the first user, identification information for identifying the railway vehicle ridden by the first user, and
identifies the railway vehicle ridden by the first user based on the identification information.

7. The information processing method according to claim 1,
wherein in the second step, the controller determines, for each user in the plurality of users, a likelihood that the user will travel to the boarding/alighting point by the specific time based on learning data indicating a behavioral pattern of each user, and
predicts the number of the users who will gather at the specific time at the boarding/alighting point based on the likelihood, determined for each user in the plurality of users, that the user will travel to the boarding/alighting point by the specific time.

8. The information processing method according to claim 1, wherein in the third step, the controller determines the vehicle dispatch schedule to dispatch an additional vehicle in a case in which the number of the users predicted to gather at the specific time at the boarding/alighting point exceeds a capacity of the vehicle.

9. The information processing method according to claim 1, wherein in the third step, the controller adjusts at least one of a number of departures of the vehicle and a departure time at the boarding/alighting point and determines the vehicle dispatch schedule in a case in which the number of the users predicted to gather at the specific time at the boarding/alighting point exceeds a capacity of the vehicle.

10. The information processing method according to claim 1, wherein in the third step, the controller
adjusts a boarding position for boarding the vehicle and determines the vehicle dispatch schedule in a case in which the number of the users predicted to gather at the specific time at the boarding/alighting point exceeds a capacity of the vehicle, and
provides notification of a boarding position for boarding the vehicle to the user who, in the determined vehicle dispatch schedule, is to board the vehicle at a different boarding position than the boarding/alighting point.

11. An information processing apparatus comprising a controller configured to:
acquire positional information indicating a change over time in positions of a plurality of users;
predict a number of the users who will gather at a specific time at a boarding/alighting point to board/alight from a vehicle based on the change over time in the positions of the plurality of users indicated by the positional information; and
determine a vehicle dispatch schedule for the vehicle to the boarding/alighting point based on the number of users predicted to gather at the specific time at the boarding/alighting point.

12. The information processing apparatus according to claim 11, wherein the controller is configured to
distinguish a type of transportation for each user in the plurality of users, and
predict the number of users who will gather at the specific time at the boarding/alighting point based further on the type of transportation distinguished for each user in the plurality of users.

13. The information processing apparatus according to claim 12, wherein the controller is configured to
identify a railway vehicle ridden by a first user whose distinguished type of transportation is a railway,
determine a likelihood that the first user will travel to the boarding/alighting point by the specific time based on an operation status of the identified railway vehicle, and
predict the number of the users who will gather at the specific time at the boarding/alighting point based further on the likelihood, determined for the first user, that the first user will travel to the boarding/alighting point by the specific time.

14. The information processing apparatus according to claim 13, wherein the controller is configured to identify the railway vehicle ridden by the first user based on a change over time in a position of the first user as indicated by the positional information.

15. The information processing apparatus according to claim 11, wherein the controller is configured to
determine, for each user in the plurality of users, a likelihood that the user will travel to the boarding/alighting point by the specific time based on learning data indicating a behavioral pattern of each user, and
predict the number of the users who will gather at the specific time at the boarding/alighting point based on the likelihood, determined for each user in the plurality of users, that the user will travel to the boarding/alighting point by the specific time.

16. The information processing apparatus according to claim 11, wherein the controller is configured to determine the vehicle dispatch schedule to dispatch an additional vehicle in a case in which the number of the users predicted to gather at the specific time at the boarding/alighting point exceeds a capacity of the vehicle.

17. The information processing apparatus according to claim 11, wherein the controller is configured to adjust at least one of a number of departures of the vehicle and a departure time at the boarding/alighting point and determine the vehicle dispatch schedule in a case in which the number of the users predicted to gather at the specific time at the boarding/alighting point exceeds a capacity of the vehicle.

18. The information processing apparatus according to claim 11, further comprising a communication interface configured to communicate with a plurality of terminal apparatuses used by the plurality of users, wherein the controller is configured to
adjust a boarding position for boarding the vehicle and determine the vehicle dispatch schedule in a case in which the number of the users predicted to gather at the specific time at the boarding/alighting point exceeds a capacity of the vehicle, and
provide notification of a boarding position for boarding the vehicle to the terminal apparatus held by the user who, in the determined vehicle dispatch schedule, is to board the vehicle at a different boarding position than the boarding/alighting point.

19. An information processing system comprising:
the information processing apparatus according to claim 18; and
the plurality of terminal apparatuses.

20. A non-transitory computer readable medium storing a program configured to cause a computer to execute:
a first process of acquiring positional information indicating a change over time in positions of a plurality of users;
a second process of predicting a number of the users who will gather at a specific time at a boarding/alighting point to board/alight from a vehicle based on the change over time in the positions of the plurality of users indicated by the positional information; and
a third process of determining a vehicle dispatch schedule for the vehicle to the boarding/alighting point based on the number of users predicted to gather at the specific time at the boarding/alighting point.
